(19) United States
(12) Patent Application Publication
(10) Pub. No.: US 2016/0374497 A1
(43) Pub. Date: Dec. 29, 2016

(54) Battery Retaining System and Method for Motorized Architectural Coverings

(71) Applicant: QMOTION INCORPORATED, Pensacola, FL (US)

(72) Inventors: Dale McCarthy, Pensacola, FL (US); Richard Scott Hand, Pace, FL (US); Robert Gorhan, Pace, FL (US); Michael D. Fox, Pensacola, FL (US)

(21) Appl. No.: 14/902,526

(22) PCT Filed: Jul. 8, 2014
(86) PCT No.: PCT/US14/04566

§ 371 Date: Dec. 31, 2015

Related U.S. Application Data
(60) Provisional application No. 61/844,450, filed on Jul. 10, 2013.

(51) Int. Cl. A47H 5/06; E06B 9/72; A47H 1/02; E06B 9/42; A47H 5/02; A47H 13/02

(52) U.S. Cl. CPC A47H 5/06; A47H 5/02; A47H 13/02; A47H 1/02; E06B 9/42; E06B 9/72; A47H 2001/0215

(57) ABSTRACT

An architectural covering is presented having a rotatable drive element. The rotatable drive element is connected to a wall, ceiling or other structure by brackets. A motor and motor controller is connected to the rotatable drive element that controls rotation thereof. A plurality of compressible members are connected to an internal surface of the rotatable drive element or a battery tube positioned within the rotatable drive element and extend outwardly therefrom and engage the exterior surface of the plurality of batteries. These compressible members hold and support the plurality of batteries while allowing for easy installation and removal. This arrangement provides an efficient, simple and convenient manner of holding a plurality of batteries in a rotatable drive element of an architectural covering.

### FIELD OF THE INVENTION

This invention relates to architectural coverings. More specifically, and without limitation, this invention relates to a system and method for retaining a battery in a motorized architectural covering.

### BACKGROUND OF INVENTION

Architectural coverings, such as curtains, shades, draperies and the like are frequently used to provide privacy and to limit the amount of light that is permitted to pass through a window and into a room or building. There are countless types, forms and designs of architectural coverings known in the art. The term architectural covering is used to describe any and all of these types, forms and designs including blinds, shades, draperies, and the like.

One form of architectural covering of particular interest in this application is a drape or drapery. Common components of draperies include a support rod connected to brackets positioned above or adjacent to a window or door. In one arrangement of a drapery product, the support rod rotates and drives the shade material across the length of the support rod. This arrangement is more fully described in Applicant's related Patent Application Ser. No. 61/702,093 filed on Sep. 17, 2012 entitled Rotatable Drive Element For Moving A Window Covering, which is fully incorporated by reference herein, including any related applications; and Applicant's related patent Application Ser. No. 61/810,949 filed on Apr. 11, 2013 entitled Rotatable Drive Element For Moving A Window Covering Including A Flexible Guide Arm And A Pointed Tooth Arrangement which is also fully incorporated by reference herein, including any related applications.

In these related patent applications, the support rod, also referred to as the rotatable drive element, rotates in place. While the rotation of the rotatable drive element is effective for driving the shade material across the length of the rotatable drive element to open and close the architectural covering, this rotation produces its own problems. Namely, so as to avoid the need to run conventional power, such as in-wall 120V service, to the drapery product it is desirable to have the drapery product be powered by replaceable batteries. However, installing the plurality of batteries into the rotatable drive element poses great challenges.

One requirement is that the batteries must be installed in a manner that does not let them rattle as that would be extremely undesirable to the user. Another requirement is that the batteries must be easily installed and easily replaced and therefore the fit within the tube must not be too tight, or too loose (so as to allow rattling). Another requirement is that the installation must ensure that the batteries remain constantly connected to one another otherwise breaks in power will occur which will affect performance of the system. Another requirement is that the solution must keep the plurality of batteries in close and tight balanced alignment so as to prevent out-of-balance wobbling.

Another problem with this arrangement is that conventional batteries such as conventional D, C, AA, AAA and the like batteries have tremendous variation in size from battery-to-battery, as well as from manufacturer-to-manufacturer. In addition, these batteries tend to vary in size over their lifetime and depending on their conditions of use. As such, a solution must be provided to deal with this variation in size.

In addition to these problems, other problems exist when attempting to install a plurality of batteries in a rotatable drive element of a drapery product.

Similar problems also exist with the use of batteries in the roll tube of a roller shade. A roller shade is a form of architectural covering having a roll tube with shade material wrapped around the roll tube and connected to a window frame or portion of a structure by brackets. As the roll tube rotates, the shade material is raised or lowered. When battery powered, similar problems exist with positioning the batteries within the roll tube as are described with positioning the batteries in the rotating drive element of the drapery product.

Thus it is a primary object of the invention to provide a battery retaining system and method for architectural coverings that improves upon the state of the art.

Another object of the invention is to provide a battery retaining system and method for architectural coverings that is easy to use.

Yet another object of the invention is to provide a battery retaining system and method for architectural coverings that is efficient.

Another object of the invention is to provide a battery retaining system and method for architectural coverings that is simple in design.

Yet another object of the invention is to provide a battery retaining system and method for architectural coverings that is inexpensive.

Another object of the invention is to provide a battery retaining system and method for architectural coverings that has a minimum number of parts.

Yet another object of the invention is to provide a battery retaining system and method for architectural coverings that has an intuitive design.

Another object of the invention is to provide a battery retaining system and method for architectural coverings that securely hold batteries in place while allowing for easy installation and removal.

Yet another object of the invention is to provide a battery retaining system and method for architectural coverings that is durable, rugged and has a long lifetime of use.

Another object of the invention is to provide a battery retaining system and method for architectural coverings that accounts for variations in battery size.

Yet another object of the invention is to provide a battery retaining system and method for architectural coverings that helps to hold a plurality of batteries in constant electrical connection.

Another object of the invention is to provide a battery retaining system and method for architectural coverings that is useful in any architectural covering having rotating batteries in a tube.

These and other objects, features, or advantages of the present invention will become apparent from the specification and claims.

### SUMMARY OF THE INVENTION

An architectural covering is presented having a rotatable drive element. The rotatable drive element is connected to a wall, ceiling or other structure by brackets. A motor and motor controller is connected to the rotatable drive element that controls rotation thereof. A plurality of compressible members are connected to an internal surface of the rotatable drive element or a battery tube positioned within the rotatable drive element and extend outwardly therefrom and engage the exterior surface of the plurality of batteries. These compressible members hold and support the plurality of batteries while allowing for easy installation and removal. This arrangement provides an efficient, simple and convenient manner of holding a plurality of batteries in a rotatable drive element of an architectural covering.

### BRIEF DESCRIPTION OF THE DRAWINGS

FIG. 1 is a perspective view of an architectural covering having a rotatable drive element having a helical guide structure in its exterior surface; the rotatable drive element is connected at its outward ends to mounting brackets, rotatable drive element extensions with finials are connected to the outward ends of the rotatable drive element.

FIG. 2 is an exploded perspective view of the architectural covering of FIG. 1 showing a rotatable drive element, mounting brackets, a motor housing positioned within the hollow interior of the rotatable drive element, a battery assembly positioned within the hollow interior of the rotatable drive element, and rotatable drive element extensions with finials connected to the outward ends of the rotatable drive element.

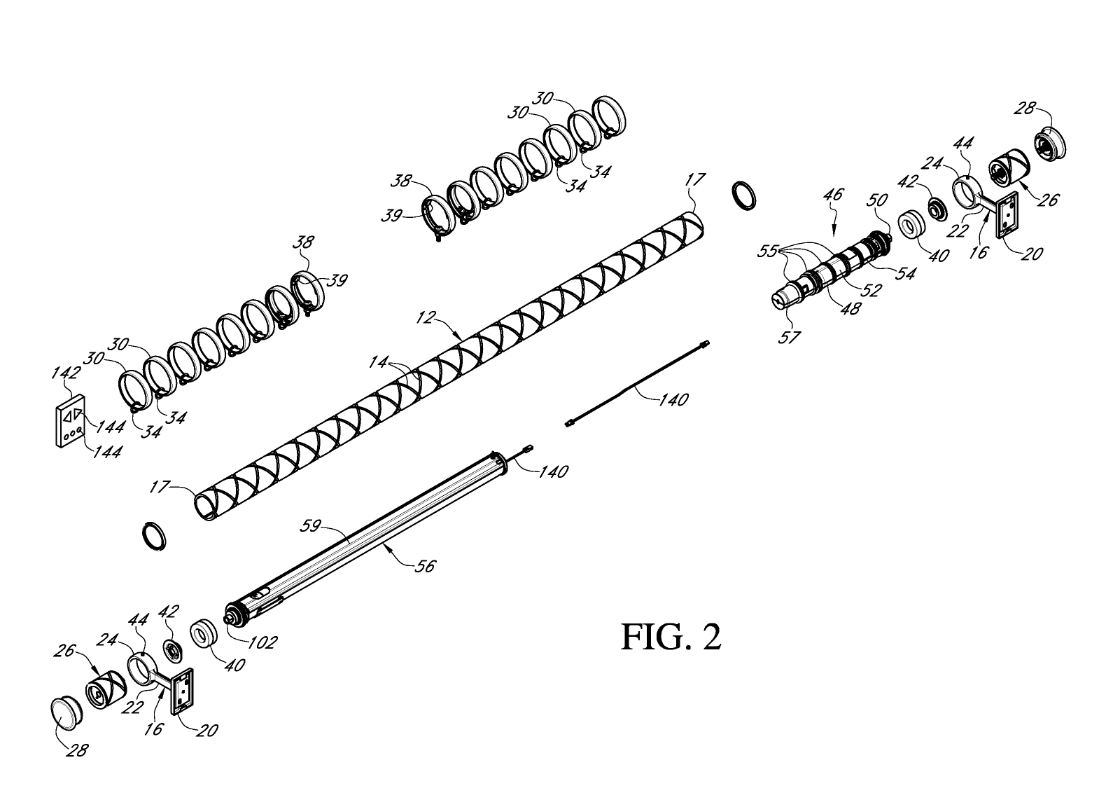

FIG. 3 is an exploded perspective view of the battery tube assembly showing the positive cap, the negative cap, the battery tube body, compressible members and the battery removal mechanism.

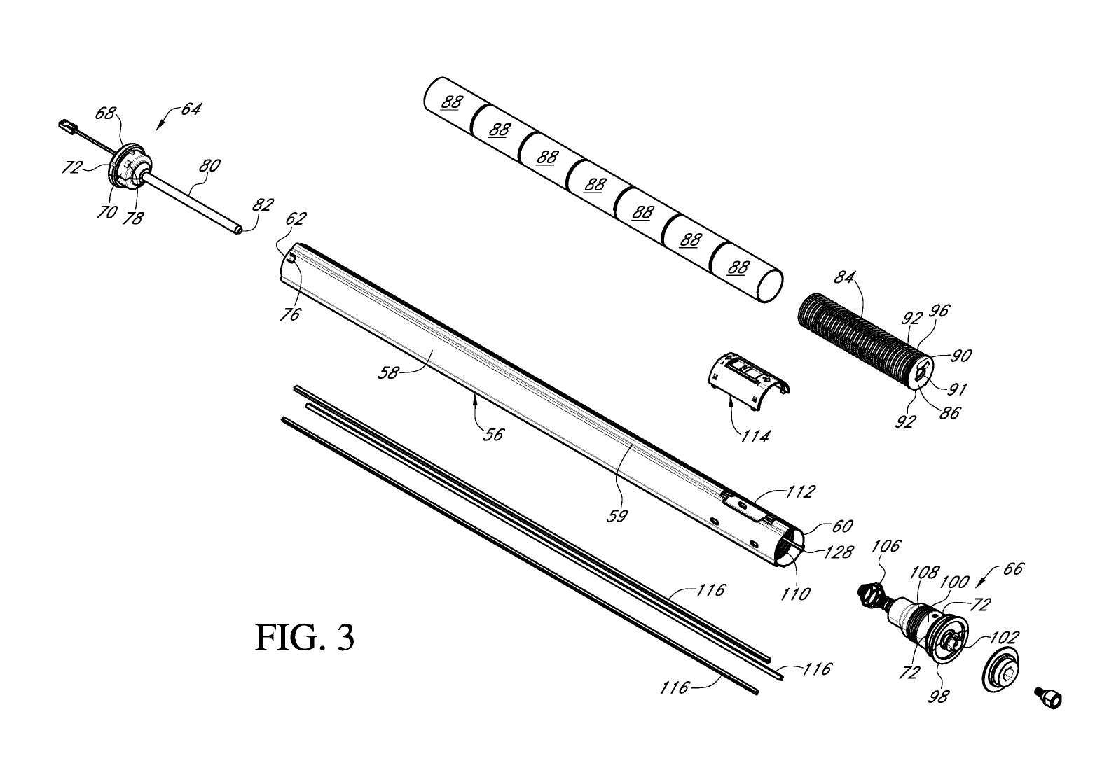

FIG. 4 is a further exploded perspective view of the battery tube assembly showing the positive cap, the negative cap, the battery tube body, the battery removal mechanism and the compressible members.

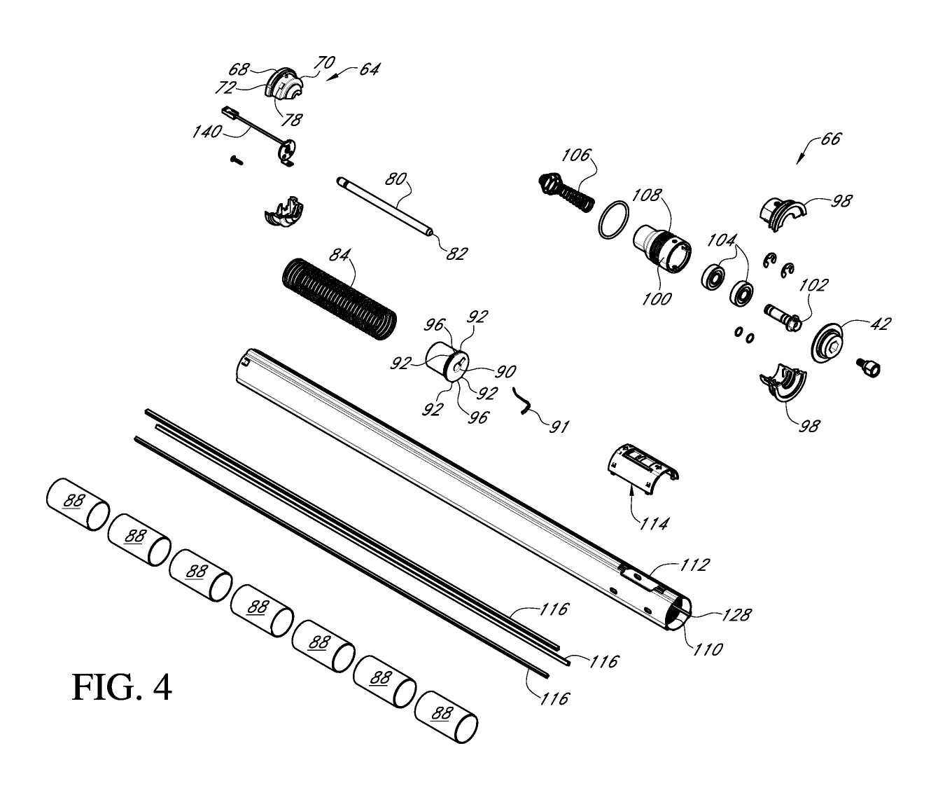

FIG. 5 is an exploded perspective view of the exterior end, or negative cap end, of the battery tube assembly showing the negative cap removed and the compressible members removed, the view also showing the recesses on the interior of the battery tube body which receive the compressible members.

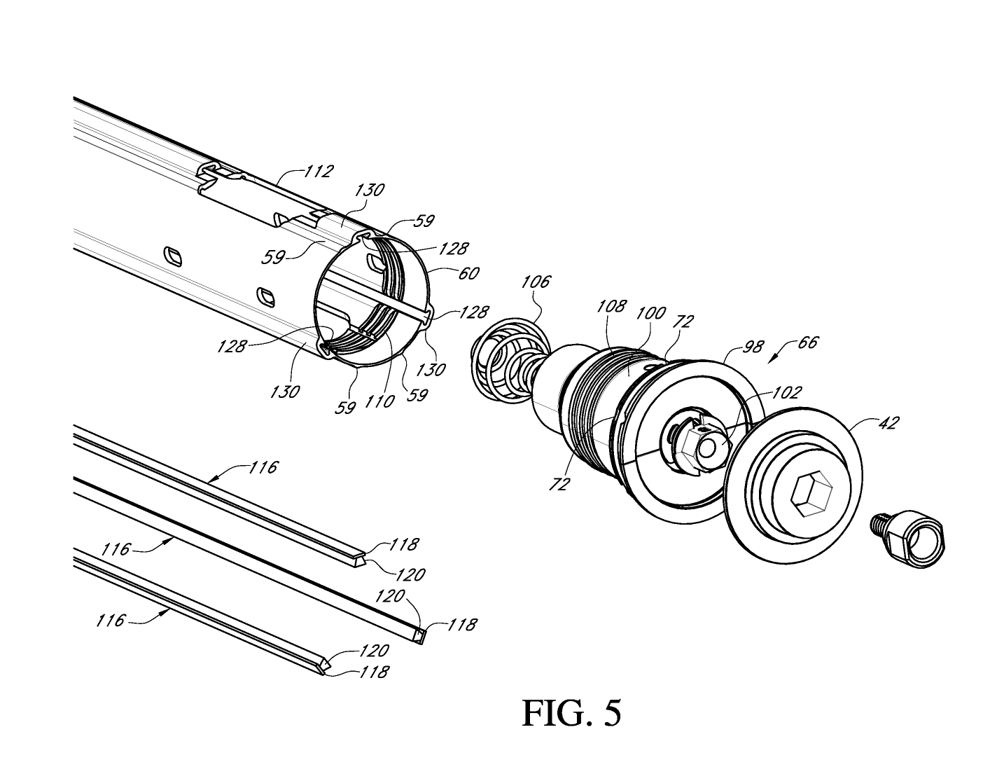

FIG. 6 is an exploded perspective view of the interior end, or positive cap end, of the battery tube assembly showing the negative cap removed and the compressible members removed, the view also showing the recesses on the interior of the battery tube body which receive the compressible members.

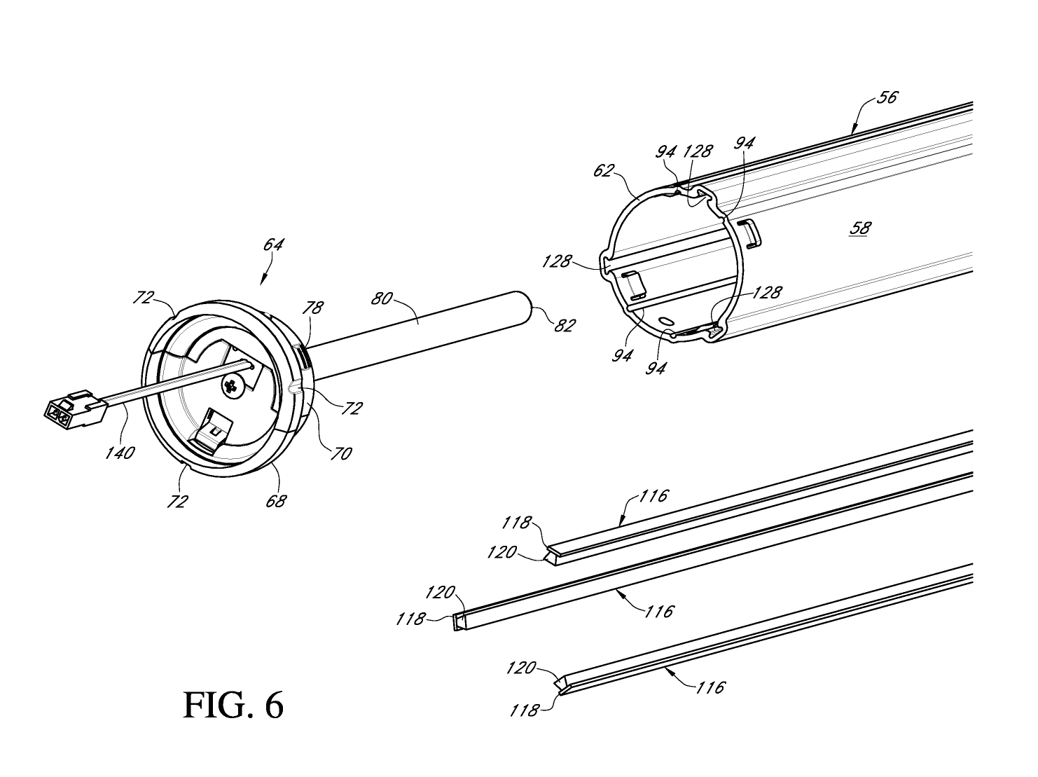

FIG. 7 is an elevation cut-away view of an end of the rotatable drive element, the view showing a battery tube assembly positioned in the rotatable drive element, the battery tube assembly having a plurality of compressible members held within recesses in the interior surface of the battery tube body, and a battery positioned within the battery tube body, the battery being in frictional engagement with the plurality of compressible members.

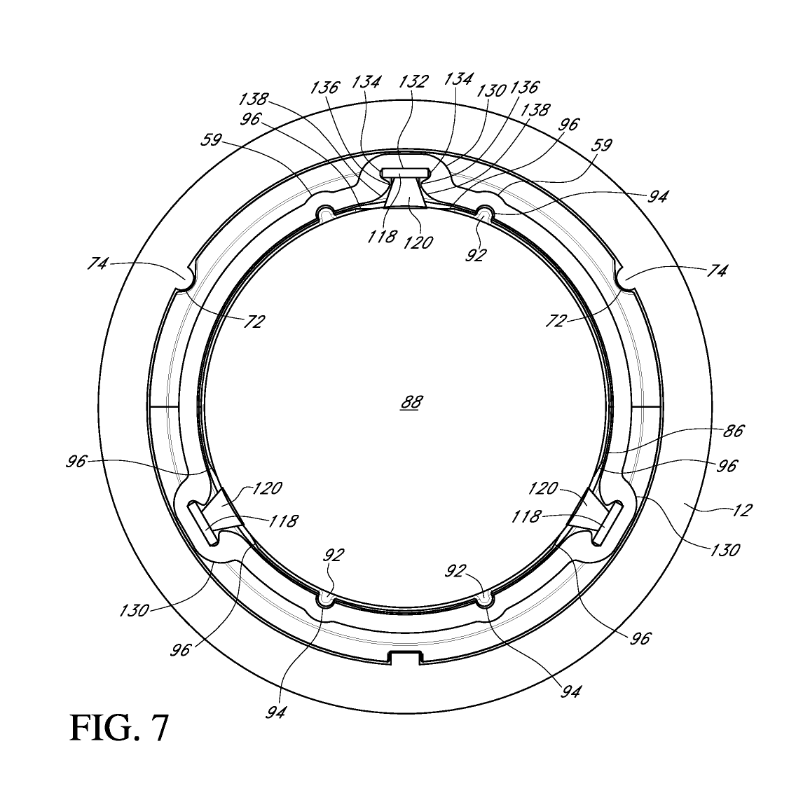

FIG. 8 is an elevation side cut-away view a battery tube assembly, the view showing the battery tube assembly closed on its ends by a positive cap and a negative cap, the view also showing one of a plurality of compressible members held within recesses in the interior surface of the battery tube body, and a plurality of batteries positioned within the battery tube body, the batteries being in frictional engagement with the compressible members.

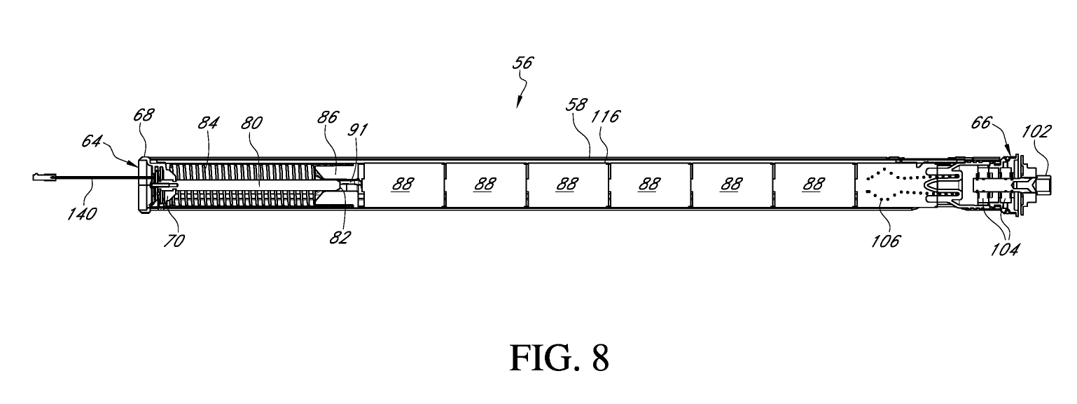

FIG. 9 is a perspective view of a plurality of compressible members, the view showing the profile of the resilient backing and the compressible material.

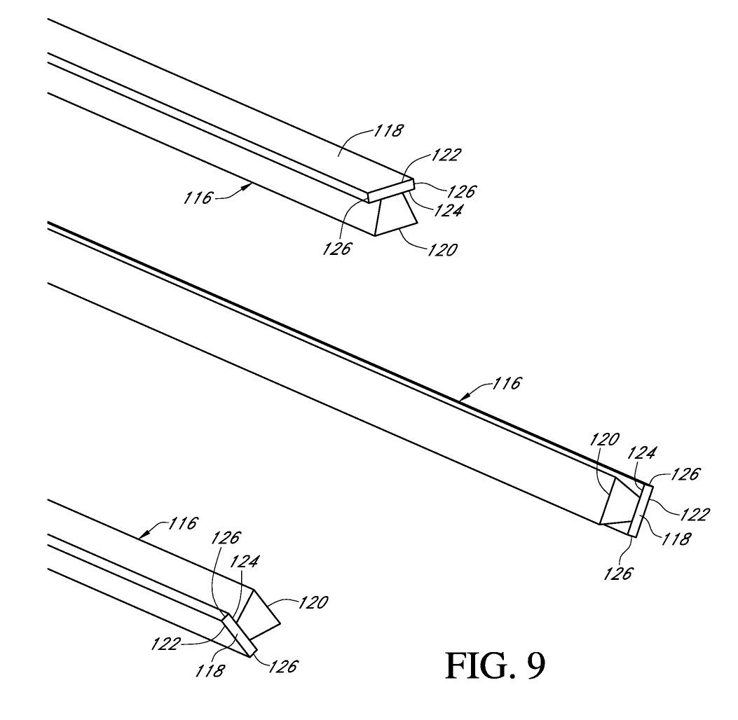

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope of the present invention is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the invention.

As used herein, the invention is shown and described as being used in association with an architectural covering in the form of a drapery product having a rotating support rod however the invention is not so limiting. Instead, one of ordinary skill in the art will appreciate that the system and method presented herein can be applied to any mechanical device, without limitation. The system and method is merely shown and described as being used in association with an architectural covering (shown as a rotating drapery rod) for ease of description and as one of countless examples. In addition, it is hereby contemplated that the system and method is equally applicable for use in a roller shade having a rotating roll tube such as those manufactured by Qmotion Advanced Shading Systems, of 3400 Copter Road, Pensacola, Fla. 32514, among other manufacturers.

As used herein, the term architectural covering refers to any covering such as a blind, drapery, roller shade, venetian blind, drapery or the like, used especially in association with windows. This term is in no way meant to be limiting. Instead, one of ordinary skill in the art will appreciate that the system and method presented herein can be applied to any architectural covering, without limitation.

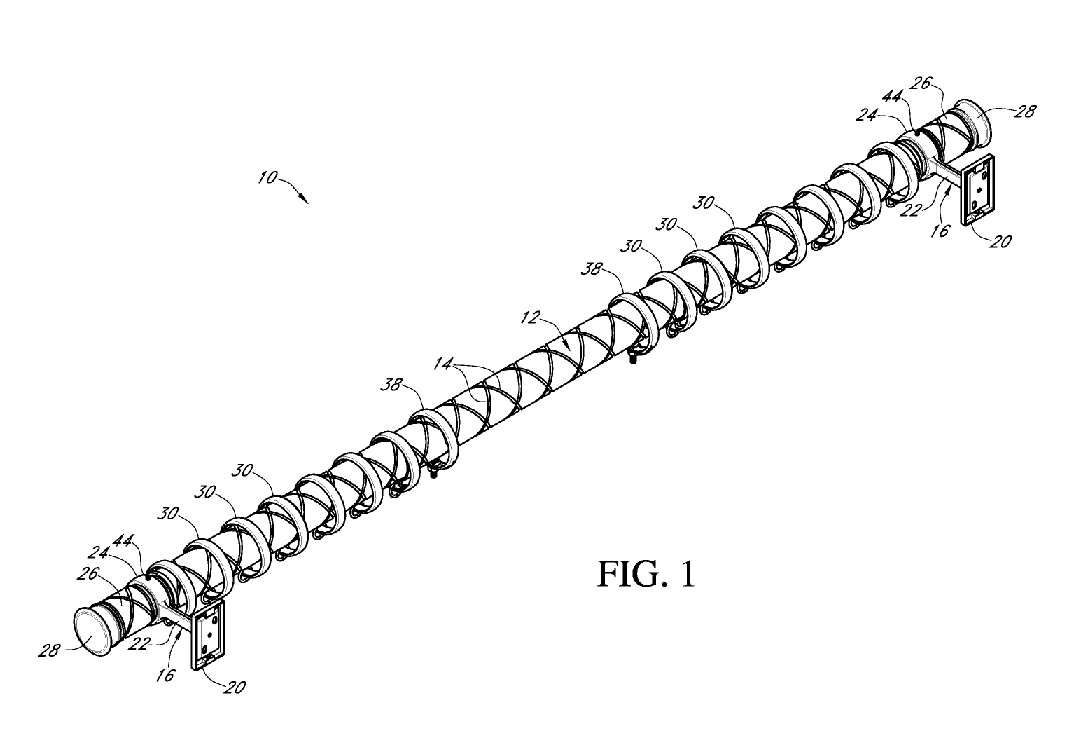

With reference to FIG. 1, an architectural covering 10 is presented. Architectural covering 10 is formed of any suitable size, shape and design. As one example, as is shown, architectural covering 10 includes a first rotatable drive element 12. The first rotatable drive element 12 is any form of a rotating member such as a rod, tube, threaded bar, or the like. In one arrangement, rotatable drive element 12 is an elongated hollow tube, having a helical guide structure 14 positioned in its surface, as is described in further detail in Applicant's related Application Ser. No. 61/702,093 filed on Sep. 17, 2012 entitled Rotatable Drive Element For Moving A Window Covering, which is fully incorporated by reference herein, including any related applications; Applicant's related patent Application Ser. No. 61/810,949 filed on Apr. 11, 2013 entitled Rotatable Drive Element For Moving A Window Covering Including A Flexible Guide Arm And A Pointed Tooth Arrangement; and Applicant's related patent Application Ser. No. 61/813,013 filed on Apr. 17, 2013 entitled Apparatus, System And Method For Supporting A Rotatable Drive Element For An Architectural Covering, all of which are fully incorporated by reference herein, including any related applications.

The helical guide structure 14 can be a left-hand guide structure, a right-hand guide structure, or both, a pair of left-hand guide structure and a pair of a right-hand guide structures, or a plurality or combination of left-hand guide structures and/or right-hand guide structures. In the arrangement shown in FIG. 1, a pair of left-hand guide structures set across from one another on opposite sides of the drive element 12 and a pair of right-hand guide structures set across from one another on opposite sides of the drive element 12 are shown, the left-hand and right-hand guide structures 14 intersect with one another perpendicularly on opposite sides of the drive element 12.

Guide structure 14 can be formed of grooves, indentations, protrusions, threads or any other feature or the like, as is described herein. Guide structure 14 can either ground or machined into the surface or rotatable drive element 12, knurled into the surface of rotatable drive element 12 (as is described further herein), cast, extruded or otherwise formed into the surface of rotatable drive element 12, or created by any other means or methods known in the art.

Wall brackets 16 support rotatable drive element 12. Wall brackets 16 are any form of a connecting device which supports and connects rotatable drive element 12 to any structural element such as a wall adjacent a window, a ceiling, a frame structure or the like. As one example, in the arrangement shown, rotatable drive element 12 is connected adjacent its outward ends 17 to wall bracket 16.

In the arrangement shown, wall brackets 16 include a mounting plate 20 which connects to the wall, an extension arm 22, which extends between mounting plate 20 and a mounting member 24. In one arrangement, as is shown, mounting member 24 is formed of any suitable size, shape and design and serves to connect to rotatable drive element 12 while allowing for functional movement, such as rotation, of the necessary parts. In one arrangement, as is shown, mounting member 24 is a generally circular collar which is sized and shaped to receive rotatable drive element 12 therein as is described further herein.

Rotatable drive element extensions 26 are connected adjacent the ends 17 of rotatable drive element 12. In the arrangement shown, the mounting member 24 of wall bracket 16 is positioned between rotatable drive element extensions 26 and the ends 17 of rotatable drive element 12. Rotatable drive element extensions 26 are formed of any suitable size and shape. In one arrangement, as is shown, rotatable drive element extensions 26 are an extension of rotatable drive element 12 and have approximately the same exterior size, shape, diameter and appearance of the rotatable drive element 12, as well as continuous extension of guide structure 14 therein. In this arrangement, when rotatable drive element extensions 26 are connected adjacent the ends 17 of rotatable drive element 12, the length of rotatable drive element 12 is relatively seamlessly extended as is the length of guide structure 14.

In one arrangement, as is shown, rotatable drive element 12 connects to rotatable drive element extension 26 at mounting member 24. In this arrangement, mounting member 24 hides or covers the seam between rotatable drive element 12 and rotatable drive element extension 26. In this arrangement, the rotatable drive element extensions 26 may or may not rotate in unison with rotatable drive element 12.

Finials 28 are connected to the outward ends 17 of rotatable drive element 12, the outward side of mounting members 24 of brackets 16 or, when used, to the outward end of rotatable drive element extensions 26. Finials 28 are any ornamental or decorative element that improves the aesthetic appearance of system 10. Finials 28 close the open ends of rotatable dive element 12 or finials 28 and are connected by any means known in the art, such as a snap-fit arrangement, threaded engagement, being welded thereto, being machined directly there into or onto, or by any other means.

Idler attachment elements 30 are connected to and positioned around rotatable drive element 12 and/or rotatable drive element extensions 26 as is described herein. Idler attachment elements 30 are formed of any suitable size and shape. In one arrangement, as is shown, idler attachment elements 30 are formed of a circular hoop member which is sized and shaped to fit loosely around rotatable drive element 12. The interior diameter of idler attachment elements 30 are larger than the maximum exterior diameter of rotatable drive element 12 such that when positioned on rotatable drive element 12, the circular idler attachment elements 30 freely slide across the length of the drive element 12. To improve this sliding, the interior diameter or surface of idler attachment elements 30 is smooth, flat and/or rounded. In addition, to improve this sliding, a lubricating coating, layer, ring or bushing is positioned on the interior diameter or surface of idler attachment elements 30, such as a coating or ring of plastic, composite, UHMW material, Teflon, nylon, ceramic, or the like that is durable and has a low coefficient of friction. Alternatively, or in addition, to improve this sliding, a coating, layer or bushing is positioned on the exterior diameter or surface of rotatable drive element 12, such as a coating, layer or ring of plastic, composite, UHMW material, Teflon, nylon, ceramic, or the like that is durable and has a low coefficient of friction. In one arrangement, wherein the rotatable drive element 12 is metallic and/or the idler attachment elements 30 are metallic, this coating, layer or bushing helps to reduce the noise of the system 10 as the coating, layer or ring is somewhat compressible and prevents clicking when the two components 12, 30 engage one another. This arrangement also prevents or reduces clicking or noises as idler attachment elements 30 pass over helical guide structure 14.

In the arrangement shown, a connection member 34 is connected to idler attachment elements 30. Connection member 34 is formed of any suitable size and shape which serves to connect idler attachment element 30 to shade material or curtain 36 (not shown). In one arrangement, as is shown, connection member 34 is a simple ring, hoop or loop that extends around circular hoop member of idler attachment element 30 and hangs down therefrom. However any form of a hook, pin hook, S-hook, curtain hook or the like is hereby contemplated. Shade material 36 (not shown) hangs down from connection member 34 which is connected to the circular hoop members of idler attachment elements 30 to cover a window or other opening in a structure.

Drive attachment elements 38, like idler attachment elements 30 are connected to and positioned around rotatable drive element 12. In the arrangement shown, drive attachment elements 38 are positioned outside of, or at the end of the row of idler attachment elements 30. In one arrangement a single drive attachment element 38 is used, whereas in an alternative arrangement two drive attachment elements 38 are used which are connected to one another by a bracket or other connecting member. The use of a pair of connected drive attachment elements 38 has been shown to provides some advantages over a single drive attachment element 38 such as better stability and less catastrophic failures.

Drive attachment element 38 is formed of any suitable size, shape and design. In one arrangement, as is shown, drive attachment element 38 has a generally circular shape with an inner diameter that is larger than the outer diameter of rotatable drive element 12, such that drive attachment element 38 can fit over and receive rotatable drive element 12. In one arrangement, the inner diameter of drive attachment elements 38 has at least one tooth 39 that is received by guide structure 14, such that when rotatable drive element 12 is rotated, drive attachment element 38 is driven across a length of rotatable drive element 12 thereby opening and/or closing the architectural covering 10.

In the arrangement shown in FIG. 1, an architectural covering 10 is shown that is center opening and closing. That is, the architectural covering 10 has two drive attachment elements 38 that drive towards and away from the center of rotatable drive element 12 depending on the direction of its rotation. The architectural covering 10 is closed when the drive attachment elements 38 are adjacent the center of the rotatable drive element 12 with the idler attachment elements 30 spaced across a length of the rotatable drive element 12. The architectural covering 10 is open when the drive attachment elements 38 are adjacent the outside wall bracket 16 with the idler attachment elements 30 stacked adjacent one another.

In one arrangement, rotatable drive element 12 is connected to brackets 16 by positioning a compressible bearing 40 into the mounting member 24 of the wall brackets 16 and tightening one or more bearing plates 42 against the compressible bearing 40 such that the diameter of the compressible bearing 40 is forced to expand and tightly engages the interior surface of mounting member 24. Once tightened by bearing plates 42, compressible bearing 40 is further held in place by tightening at least one lock screw 44 through mounting member 24 and into the exterior surface of compressible bearing 40. In this way, a firm but somewhat resilient and shock absorbing mount is provided.

Motor Housing, Motor & Motor Controller: A motor housing 46 is connected to rotatable drive element 12. Motor housing 46 is formed of any suitable size, shape and design. In one arrangement, as is shown, motor housing 46 is sized and shaped such that it is positioned within the open interior of rotatable drive element 12 adjacent an end 17. In an alternative arrangement, motor housing 46 is positioned within one of the rotatable drive element extensions 26.

Motor housing 46 includes a motor 48. Motor 48 is any form of a motor that converts electrical energy to mechanical energy. In the arrangement shown, a shaft 50 of motor 48, or operably connected to motor 48, is operably connected to a wall bracket 16 while the body 52 of motor housing 46 is connected to the interior surface of the hollow rotatable drive element 12. In this way, as the motor 48 rotates, shaft 50 remains stationary while body 52 rotates, thereby rotating rotatable drive element 12.

Motor 48 is connected to a motor controller 54. Motor controller 54 includes some or all the components to control motor 48 and to control operation of the architectural covering 10. Motor controller 54 is any device which controls the operation of motor 48. In one arrangement, motor controller 54 includes an electrical circuit board or PC board which includes and is electrically connected to a microprocessor, memory, a receiver or transceiver and an antenna. The microprocessor is any programmable device that accepts analog or digital signals or data as input, processes it according to instructions stored in its memory, and provides results as output. The microprocessor receives signals from receiver or transceiver and processes them according to its instructions stored in its memory and then controls motor based on these signals. The memory is any form of electronic memory such as a hard drive, flash, ram or the like. The antenna is any electronic device which converts electric power into electromagnetic signals or electromagnetic waves, which are commonly known as radio waves or RF (radio frequency) (hereinafter collectively referred to as “electromagnetic signals” without limitation). The antenna can transmit and/or receive these electromagnetic signals. In one arrangement these electromagnetic signals are transmitted via AM or FM RF communication, while any other range of RF is hereby contemplated. In the arrangement shown, a meandering antenna or fractal antenna is used adjacent the font or outward side of motor housing 46 for purposes of strong reception, however any other form of an antenna is hereby contemplated. The motor controller 54 is also electrically connected to a power source such as battery tube assembly 56.

To detect rotation of rotatable drive element 12, a sensor assembly 57 is connected to motor housing 46, motor 48, motor controller 54 or any other portion of the architectural covering 10. The sensor assembly 57 is any form of a device which senses the rotation or position of architectural covering 10, such as reed switches, mechanical encoders, magnetic encoders, or the like. In one arrangement, the sensor assembly includes a magnet connected to a shaft of the motor 48 such that when shaft rotates, so rotates magnet. Positioned adjacent the magnet is at least one, Hall Effect sensor. This arrangement is more fully described in Applicant's related patent application entitled Low-Power Architectural Covering Ser. No. 61/811,650 filed on Apr. 12, 2013 which is fully incorporated by reference herein, among other applications which are incorporated herein by reference.

In the arrangement shown, the exterior surface of motor housing 46 includes features 55 that are sized and shaped to engage similar, but opposite, features in the interior surface of rotatable drive element 12. In this way, motor housing 46 is sized and shaped to slide in an open end 17 of rotatable drive element 12. However due to the engagement of features 55 of the motor housing 46 with corresponding features in the interior surface of rotatable drive element 12, motor housing 46 is prevented from rotating with respect to the rotatable drive element 12. However, in an alternative arrangement, the motor housing 46 remains stationary as the rotatable drive element 12 is rotated.

Battery Tube Assembly: A battery tube assembly 56 is connected to rotatable drive element 12. Battery tube assembly 56 is formed of any suitable size, shape and design. In one arrangement, as is shown, battery tube assembly 56 is sized and shaped such that it is positioned within the open interior of rotatable drive element 12 adjacent an end 17. In the arrangement shown, motor housing 46 is positioned within one open end 17 of rotatable drive element 12 while battery tube assembly 56 is positioned within the opposite open end 17 of rotatable drive element 12. In an alternative arrangement, battery tube assembly 56 is positioned within one of the rotatable drive element extensions 26.

In one arrangement, as is shown, battery tube assembly 56 has a battery tube body 58 which is a hollow elongated generally tubular shaped member which is sized and shaped to fit within and frictionally engage the open interior of rotatable drive element 12, similar to motor housing 46. To that end, the exterior surface of battery tube body 58 includes features 59 that are sized and shaped to engage similar, but opposite, features in the interior surface of rotatable drive element 12. In this way, battery tube assembly 56 is sized and shaped to slide in an open end 17 of rotatable drive element 12. However due to the engagement of features 59 of the battery tube assembly 56 with corresponding features in the interior surface of rotatable drive element 12, battery tube assembly 56 is prevented from rotating with respect to the rotatable drive element 12. However, in an alternative arrangement, the battery tube assembly 56 remains stationary as the rotatable drive element 12 is rotated.

Battery tube body 58 extends between an outside end 60 and an inside end 62. When installed within rotatable drive element 12, outside end 60 is positioned adjacent a wall bracket 16 and is slightly recessed, approximately flush with, or slightly extends outwardly from end 17 of the rotatable drive element 12; whereas the inside end 62 is positioned within the length of rotatable drive element 12. A positive cap 64 and a negative cap 66 are connected to opposing ends of battery tube body 58. In one arrangement, positive cap 64 is connected to the inside end 62 of battery tube body 58 and negative cap 66 is connected to the outside end 60 of battery tube body 58, however the opposite arrangement is hereby contemplated as well.

Positive Cap: Positive cap 64 encloses the inside end 62 of battery tube body 58. Positive cap 64 is formed of any suitable size, shape and design. In one arrangement, as is shown, positive cap 64 has a generally circular exterior shape when viewed from its end. Positive cap 64 has an exterior flange 68 which connects to a circular body 70. Flange 68 has an exterior diameter which is larger than the exterior and/or interior diameter of battery tube body 58; whereas body 70 of positive cap 64 has an exterior diameter which is sized and shaped to fit within the open interior end of battery tube body 58. In this way, when positive cap 64 is connected to and fully installed on the inside end 62 of battery tube body 58, body 70 is inserted within the open interior of battery tube body 58 while flange 68 remains exterior to the open interior of battery tube body 58. In this position, the inside edge of flange 68 adjacent body 70 is in flush engagement with the inside end 62 of battery tube body 58.

The exterior periphery of flange 68 includes alignment recesses 72 which are sized and shaped to align with and engage alignment protrusions 74 positioned along the interior surface of rotatable drive element 12. Alignment recesses 72 and alignment protrusions 74 are in engagement with one another when battery tube assembly 56 is inserted within rotatable drive element 12 ensuring that as the rotatable drive element 12 rotates, so rotates battery tube assembly 56. In one arrangement, similar alignment recesses 72 are positioned in negative cap 66 and serve the same purpose.

Locking detents 76 are positioned in the inside end 62 of battery tube body 58. In one arrangement, as is shown, locking detents 76 are formed of a resilient flange of material that is cut and bent downwardly from the battery tube body 58 such that it extends inwardly into the open interior of battery tube body 58 at a slight angle from the inside end 62 to the outside end 60. These locking detents 76 align with and are matingly received by locking recesses 78 in the body 70 of positive cap 64. As positive cap 64 is installed on the interior end 62 of batter tube body 58, locking detents 76 deflect until they are lockingly received within locking recesses 78. In this way, the two components are held together. In an alternative arrangement, locking detents 76 are merely openings in the battery tube body 58 and locking recesses 78 are protrusions received with the locking detents 76 thereby holding the two components together. Alternatively, any other means or methods of connecting the two devices together is hereby contemplated for use, such as a threaded engagement, a J-slot engagement, welding, gluing, adhering, a spring detent or the like.

A support rod 80 is connected to positive cap 64 and extends outwardly therefrom into the interior of battery tube body 58. Support rod 80 is formed of any suitable size, shape and design. The support rod 80 extends a length before terminating in end 82. A compression spring 84 is connected to the positive cap 64 at its inside end and extends around and is supported and aligned by support rod 80. A plunger 86 is connected to compression spring 84 adjacent its outside end.

Plunger 86 is sized and shaped to fit within the open interior of battery tube body 58 and slide laterally therein. Plunger 86 is naturally forced towards negative cap 66 by the force of compression spring 84; whereas as batteries 88 are inserted into battery tube assembly 56 plunger 86 is forced towards the end 82 of support rod 80.

End 82 of support rod 80 which protrudes into the open interior of battery tube assembly 56 defines the inward most limit batteries 88 can travel towards positive cap 64. In one arrangement, when a complete set of batteries 88 are installed within battery tube assembly 56, the inward most end 82 of support rod 80 contacts an electrical contact of batteries 88 and thereby serves as an electrical contact point for the battery tube assembly 56. To facilitate this arrangement, a generally centrally positioned opening 90 is positioned in plunger 86 which is sized and shaped to allow end 82 of support rod 80 to pass there through. Alternatively, to ensure constant contact with batteries 88, especially when the system 10 is in motion, a contact spring 91 is placed within the opening 90 of plunger 86. This contact spring 91 connects between the end 82 of support rod 80 and the positive lead of the inward most battery 88. In this way, the contact spring 91 helps to maintain constant contact to the plurality of batteries 88.

The exterior periphery of plunger 86 has a plurality of plunger alignment features 92 therein which are sized and shaped to align with interior battery tube alignment features 94. In one arrangement, as is shown, plunger alignment features 92 are formed of two pairs of rounded protrusions, the pairs of rounded protrusions are positioned on opposite sides of the plunger 86. In this arrangement, the interior battery tube alignment features 94 are formed of matching rounded recesses. When plunger 86 is inserted within battery tube body 58 these alignment features 92, 94 mate with one another thereby providing precise proper alignment of plunger 86 within battery tube body 58 as it slides between a fully extended position and a fully retracted position.

Also positioned in the exterior periphery of plunger 86 is at least one clearance feature 96. Clearance feature 96 provides clearance for other components of the system as is further described herein. When viewed from its end, three clearance features 96 are positioned in exterior periphery of plunger 86, each clearance feature 96 is formed of a flat plane in the round exterior surface of plunger 86.

Negative Cap: Negative cap 66 encloses the outside end 60 of battery tube body 58. Negative cap 66 is formed of any suitable size, shape and design. In one arrangement, as is shown, negative cap 66 has a generally circular shape when viewed from its end. Negative cap 66 has an exterior flange 98 which connects to a circular body 100. Flange 98 has an exterior diameter which is larger than the exterior and/or interior diameter of battery tube body 58; whereas body 100 of negative cap 66 has an exterior diameter which is sized and shaped to fit within the open outside end 60 of battery tube body 58. In this way, when negative cap 66 is connected to and fully installed on the outside end 60 of battery tube body 58, body 100 is inserted within the open interior of battery tube body 58 while flange 68 remains exterior to the open interior of battery tube body 58. In this position, the side of flange 98 adjacent body 100 is in flush engagement with the outside end 60 of battery tube body 58.

An axel 102 is connected to negative cap 66 and extends outwardly and away from outside end 60. Axel 102 rotates on at least one bearing 104, such as a roller bearing, positioned within negative cap 66. In this arrangement, axel 102 is connected to bracket 16 and remains stationary while bearing(s) 104 allow for rotation of battery tube assembly 56.

A negative spring 106 extends inwardly from inward end negative cap 66. Negative spring 106 provides pressure on batteries 88 within battery tube assembly 56 in the direction opposite compression spring 84.

Negative cap 66 is removably and replaceable on battery tube assembly 56 so as to facilitate removal and replacement of batteries 88. Negative cap 66 is connected to the outside end 60 of battery tube body 58 by any means. In the arrangement shown, body 100 includes a key feature 108 which protrudes from the generally cylindrical surface of body 100. In one arrangement, key feature 108 is a cylindrical protrusion, knob, bump, threads or the like which is sized and shaped to be lockingly, removeably and replaceably engaged in in key slot 110 positioned in the interior surface of the outside end 60 of battery tube body 58. In the arrangement shown, key slot 110 is a J or L-shaped channel which receives key feature 108 and holds it therein when in use. Any other means or methods of connecting the two devices together are hereby contemplated for use, such as a snap-fit arrangement, a spring detent or the like.

Battery Removal Mechanism: A battery removal opening 112 is positioned in the battery tube body 58 near or adjacent its outside end 60. Battery removal opening 112 is sized and shaped to allow batteries 88 to inserted and removed there through. A battery removal mechanism 114 is connected to the battery tube body 50 over and/or in engagement with battery removal opening 112. Battery removal mechanism 114 serves to help a user remove batteries 88 one at a time without having to remove the entire battery tube assembly 56 from rotatable drive element 12, and further eliminates the need to remove the positive cap 64 or negative cap 66 to remove or replace the batteries 88. This improves the ease of battery removal and replacement and improves the safety of the device as a user does not have to unleash the full power of the compression spring 84 when replacing batteries 88. In one arrangement, battery removal mechanism 114 works in a similar fashion to a shotgun shell tube mechanism wherein a single battery is released or inserted at a time, as is known in the art.

Compressible Members: The interior diameter of battery tube body 58 is generally circular in shape and is generally sized and shaped within close tolerances to receive the generally circular exterior shape of batteries 88. However, because conventional batteries 88 have a tremendous amount of size variation from battery-to-battery, not to mention from manufacturer-to-manufacturer, it is difficult to properly size the interior diameter of battery tube body 58 to accommodate the variation in battery size without having some batteries being so loose that they rattle around within the battery tube body 58 while others are too big to fit within battery tube body 58. Further complicating matters, batteries 88 tend to vary in size over their lifetime, which can cause batteries 88 to get stuck within the battery tube body 58 if the tolerances are too tight. Further still, environmental conditions, such as temperature, sunlight and humidity can drastically affect the size of the batteries. This dimensional variance causes a battery that previously fit within the tube to get stuck, or vise versa. Further complicating matters, the battery tube assembly 56, which is inserted into the rotatable drive element 12, rotates which causes the batteries 88 to rotate. If the batteries 88 are not properly suspended or held in place this can cause them to break electrical connection with one another and cause further electrical problems including interruption in the operation of architectural covering 10.

To alleviate this problem a plurality of compressible members 116 are positioned within the open interior of battery tube body 58. Compressible members 116 are formed of any suitable size, shape and design. In one arrangement, as is shown, compressible members 116 are formed of a resilient backing 118 to which a compressible material 120 extends outwardly therefrom on one side. When viewed from the side, resilient backing is generally rectangular in shape with an opposing bottom surface 122 and a top surface 124 extending in generally parallel spaced relation to one another. Bottom surface 122 and top surface 124 terminate in sidewalls 126. Sidewalls 126 extend in generally parallel spaced relation to one another and extend in generally perpendicular spaced relation to top surface 124 and bottom surface 122.

Compressible material 120 is connected to resilient backing 118 and extends outwardly from its top surface 124 a distance. In one arrangement, compressible material 120 is generally centrally located within the top surface 124, such that a portion of resilient backing 118 extends along the bottom edge of compressible material 120. Compressible material 120 rises above resilient backing 118 in a column. While compressible material 120 is generally formed in a rectangular column, compressible material 120 has a tendency to expand outwardly in a triangular shape or V-shape as it rises away from resilient backing 118. This is because, in one arrangement, the compressible material 120 is formed of a plurality of strands, fibers, or bristles that are captured at their bottom end within resilient backing 118, however as they extend outwardly from resilient backing 118 they push away from one another into the triangular or V-shape. This triangular expansion is further caused in use when batteries 88 further force the strands or fibers of the compressible member 120 outward from one another.

In one arrangement, compressible members 116 are elongated members that extend the entire length of battery tube assembly 56, or extend a majority of the length of battery tube assembly 56. In an alternative arrangement, compressible members 116 only extend the length of battery tube body 58 that is occupied by batteries 88.

Compressible members 116 are positioned within battery tube body 58 such that the compressible material 120 extends inwardly towards the open interior of battery tube body 58 such that the compressible material 120 engages the exterior surface of batteries 88 when positioned therein. In this arrangement the bottom surface 122 of resilient backing 118 faces battery tube body 58 or is adjacent or in flush engagement with the interior surface of battery tube body 58.

Compressible members 116 are connected to battery tube body 58 by any means known in the art. In one arrangement, as is shown, resilient members 118 fit within a recess 128 in the interior surface of battery tube body 58. Recess 128 is formed of any suitable size, shape and design. As one example, as is shown, recess 128 forms a C-shaped channel or groove when battery tube body 128 is viewed from an end. This C-shaped channel is spatially positioned outward from the generally circular interior surface of battery tube body 58 so as to provide the proper clearance for compressible member 116 therein. A protrusion 130 is formed in the exterior surface of battery tube body 58 to accommodate the recess 128. In addition to providing space for recesses 128, these protrusions 130 also provide structural rigidity to battery tube assembly 56, in the same way corrugation does in a sheet of steel, while reducing the amount of material needed.

The C-shaped channel of recess 128 is sized and shaped to receive resilient backing 118 within close tolerances such that resilient backing 118 can easily be slid therein and easily removed while not being too loose. To accomplish this appropriate frictional engagement, the C-shaped channel of recess 128 has a generally flat back wall 132 against which the bottom surface 122 of resilient member is positioned in generally parallel spaced alignment and frictional engagement. Back wall 132 is connected to ends 134 which terminate in a point 136. Ends 134 connect at their rearward side to back wall 132 and at their forward side to point 136 are generally rounded or arcuate in shape and extend therebetween forming a concave shape. When resilient backing 118 is positioned within recess 128, sidewalls 126 are positioned adjacent ends 134. However, because sidewalls 126 are generally flat, while ends 134 are generally arcuate, a space is left therebetween which provides adequate clearance for resilient backing 118. The forward side of ends 134 curve past the sidewalls 126 of resilient backing 118 and terminate in point 136. Opposing points 136 are positioned inward from sidewalls 126 of resilient backing 118 thereby capturing resilient backing 118 within the C-shaped channel formed by points 136, ends 134 and back wall 132. Opposing points 136 terminate adjacent to where compressible material 120 extends out of resilient backing 118. In one arrangement the distance between points 136 is less than the thickness of compressible material 120, in this arrangement points 136 engage and pinch compressible material 120. In another arrangement, as is shown, the distance between points 136 is more than the thickness of compressible material 120, in this arrangement points 136 are near but do not pinch the compressible material 120.

Points 136 are positioned below or exterior to the circular inner surface of battery tube body 58 so as to not interfere with the open interior of battery tube body 58. An arcuate or rounded edge 138 connects points 136 to the circular interior surface of battery tube body 58. In the arrangement shown, edge 138 is smooth with a convex shape facing the interior surface of battery tube body 58. This rounded or arcuate edge 138 helps guide compressible material 120 outwardly as it is compressed when in engagement with batteries 88. In the arrangement shown, edge 138 is sloped and provides a surface for compressible material 120 to relax upon when compressed, such as when a battery 88 is positioned within battery tube body 58.

In one arrangement, battery tube body 58 is formed of an extruded metallic material such as aluminum or aluminum alloy for strength and minimum weight. The rounded edges of the battery tube body 58 described herein are convenient and easily formed through an extrusion process with close and tight tolerances. Accordingly, in one arrangement, the features of battery tube body 58 extend the length of the battery tube body 58 in an uninterrupted manner. Alternatively, the features described in the battery tube body 58 only extend a portion of the length of the battery tube body 58.

When the resilient backing 118 is positioned within the recess 128, compressible material 120 extends outwardly from recess 128 and between the opposing points 136. The inner most edge of compressible material 120 extends a distance into the open interior of battery tube body 58. That is, the inner most edge of compressible material 120 extends past the generally circular interior surface of battery tube body 58. In this way, when batteries 88 are positioned within battery tube body 58, compressible material 120 is forced to engage the exterior surface of batteries 88.

In the arrangement shown, three compressible members 116 are positioned within the battery tube body 58. These compressible members 116 are approximately equally spaced to one another. That is, they are positioned approximately at 120° to one another. In this way, a battery 88 is suspended on three points within battery tube body 58. Any other number of compressible members 116 are hereby contemplated for use such as 1, 2, 4, 5, 6, 7, 8, 9, 10 or more. Or, alternatively the entirety of the interior of battery tube body 58 is lined with compressible members 116.

In one arrangement compressible members 116 are formed of what is conventionally known as Wool Pile. Wool pile generally consists of a somewhat rigid and resilient yet somewhat flexible backing 118 with a strip of fibers 120 connected to or formed into the resilient backing 118 and extending upwardly therefrom. The resilient backing 118 is often formed of a PVC material, a plastic material, an UHMW material or any other composite material. The fibers 120 are often formed of a similar PVC material, a plastic material, an UHMW material or any other composite material, or alternatively a naturally occurring material is used such as wool. In some arrangements, one or more sheets of plastic film or rubber is connected to the resilient backing and extends upwardly through approximately the middle of the fibers. This arrangement of wool pile is commonly referred to as thin seal.

Any other device or object can be used as compressible material 120. Other materials and arrangements include a rubber or synthetic rubber material, a foam material, a cloth or woven material, a bubble material, resilient fingers, spring loaded members, flexible members or any other material or arrangement.

As can be seen in the end view of battery tube body 58 with the compressible members 116 installed within recesses 128, the compressible material 120 aligns with clearance features 96 in plunger 86. In the arrangement shown, clearance features 96 are flat planes in the rounded exterior surface of plunger 86. These clearance features 96 are recessed just enough to avoid engagement with the compressible material 120 so as to prevent resistance between the two components. In this way, plunger 86 does not engage, or barely engages, the compressible material 120. This arrangement extends the longevity of life of compressible material 120 and prevents plunger 86 from getting hung up or suspended in the compressible material 120.

In Operation: Wherein the architectural covering 10 is a drapery product, the battery tube assembly 56 is assembled by inserting the resilient backing 118 of compressible members 116 into the recesses 128 on the interior surface of battery tube body 58. The compressible members 116 are slid down the length of the battery tube body 58 and cut to length such that they extend at least the length of the battery tube body 58 wherein batteries 88 are installed. The positive cap 64, plunger 86 and compression spring 84 are inserted into the outside end 60 of the battery tube body 58. When installing these components, the alignment features 92 in the plunger 86 are aligned with the interior battery tube alignment features 94 and the locking detents 76 are aligned with the locking recesses 78. Positive cap 64 is locked in place when the locking detents 76 lockingly engage the locking recesses 78. In this position, plunger freely slides within the battery tube body 58 with the clearance features 96 sliding just above or slightly in engagement with the interior most end of compressible material 120 of compressible members 116.

Battery removal mechanism 114 is installed onto or over battery removal opening 112. Negative cap 66 is installed onto the opposite end of battery tube body 58 as is positive cap 64. To do so, the key feature 108 is aligned with the key slot 110 and engaged together such as by rotating or the like.

Batteries 88 are installed within the hollow interior of battery tube body 58 in one of two ways. In one manner, the batteries 88 are slid through an open end of the battery tube body 58 prior to installing one of the positive cap 64 or negative cap 66. Alternatively, the batteries 88 are installed through the battery removal mechanism 114, one at a time. This installation process is much like inserting shotgun shells in a shell tube of a shotgun. When a full complement of batteries 88 a installed in battery tube body 58, the end 82 of support rod 80 or contact spring 91 engages an electrical contact point on the inward most end of the inward most battery 88 while the compression spring 84 provides a pushing force against the batteries 88 holding them in electrical contact with one another. Simultaneously, the negative spring 106 engages the outward most end of the outward most battery 88 and provides a pushing force in the direction opposite the compression spring 84. In this position, the compliment of batteries 88 are in electrical connection with one another in end-to-end relationship.

Electrical lead 140 extends out of the inward end of battery tube assembly 56 and electrically connects to motor housing 46 thereby electrically connecting batteries 88 to all the electronic components of the motor housing 46 thereby completing the electrical circuit. In this arrangement, electrical lead 140 includes a positive lead, which is electrically connected to the positive cap 64, and a negative lead, which is electrically connected to the negative cap 66; the electrical lead 140 similarly connects to the positive and negative ends of the electrical components of motor housing 46 thereby completing the electrical circuit.

In this position, the batteries 88 are suspended within battery tube body 58 by engagement with the plurality of compressible members 116 positioned within battery tube body 58. The exterior surface of batteries 88 engages the compressible material 120 of compressible members 116. The compressible material 120 is resilient to the point where it is strong enough to support or suspend the batteries 88 preventing the batteries 88 from contacting the interior surface of the battery tube body 58, while not being so stiff that the batteries 88 cannot be removed.

Also, the coefficient of friction of the compressible material 116 is selected such that it allows for the batteries 88 to be easily slid in a lateral direction in and out of the battery tube body 58, while not allowing for unintentional movement or sliding.

As the batteries 88 crush or displace the compressible material 120, the compressible material 120 tends to mushroom outward. This compression is guided by the rounded edges 130 of recesses 128 which helps to maintain suspension of the batteries 88 overtime and prevents contact of the batteries with the battery tube body 58 even after a long period of use.

Once the battery tube assembly 56 is fully assembled and the batteries 88 are installed therein, battery tube assembly 56 is inserted in an open end 17 of rotatable drive element 12. In this position, axel 102 extends outwardly from end 17. Motor housing 46 is inserted in the opposite end 17 of rotatable drive element 12 and is electrically connected to and powered by battery tube assembly 56 through electrical contact 140. In this position, axel 102 extends outwardly from end 17.

Once fully assembled, the shaft 50 and axel 102 are rotatably connected to brackets 16 which are installed on a structure, such as a wall or ceiling near a window. Rotatable drive element extensions 26 are installed connected to the assembly on the side of bracket 16 opposite rotatable drive element 12 and finials 28 are connected to the outward ends of rotatable drive element extensions 26.

The shade material 36 is opened and closed by electrically powering motor 48 which causes motor housing 46 to rotate causing rotatable drive element 12 to rotate. Rotation is supported by shaft 50 and axel 102 connected to brackets 16. This also causes battery tube assembly 56 to rotate with rotatable drive element 12. Because batteries 88 are suspended by compressible members 116, the batteries 88 do not move, or barley move within battery tube assembly 56 thereby preventing wobbling or rattling. In addition, the batteries 88 do not break electrical connection with one another. In addition, batteries 88 do not cause any other negative effects to the assembly, such as unnecessary wear.

In one manner of operation, the system is operated by a remote control 142. When a button 144 of remote control is pressed this sends a wireless signal that is received by the motor controller 54, processed by the microprocessor which operates the motor 48. The architectural covering 10 is opened by rotating the motor 48 in one direction and closed by rotating the motor 48 in the opposite direction. In this way the architectural covering 10 is operated wirelessly with remote 142.

While this arrangement has been primarily discussed with respect to a drapery product, this arrangement and the use of compressible members 116 within the battery tube assembly 56 is equally applicable in any architectural covering 10 such as a roller shade, a Venetian shade, a honeycomb shade, or the like with the same benefits. Specifically, this arrangement is contemplated for use in a roll tube of a roller shade, such as those manufactured by QMotion Incorporated, of 3400 Copter Road, Pensacola Fla. In addition, as one variation to the assembly, the batteries 88 are installed directly into the rotatable drive element 12. That is, the battery tube assembly 56 is eliminated and the recesses 128 are placed directly into the rotatable drive element 12 thereby eliminating the need for a separate battery tube assembly 56 within the rotatable drive element 12. In this arrangement, the compressible members 116 are installed in the interior surface of the rotatable drive element 12.

From the above discussion it will be appreciated that system and method shown and described herein provides a battery retaining system and method for architectural coverings that improves upon the state of the art.

Specifically, the battery retaining system and method for architectural coverings presented is easy to use, is efficient, is simple in design, is inexpensive, has a minimum number of parts, has an intuitive design, securely holds a batteries in place while allowing for easy installation and removal, is durable, rugged and has a long lifetime of use, accounts for variations in battery size, helps to hold a plurality of batteries in constant electrical connection, is useful in any architectural covering having rotating batteries in a tube, among countless other advantages.

It will be appreciated by those skilled in the art that other various modifications could be made to the device without parting from the spirit and scope of this invention. All such modifications and changes fall within the scope of the claims and are intended to be covered thereby.

What is claimed:

1. An architectural covering comprising: a rotatable drive element having a hollow interior, a battery tube assembly positioned within the hollow interior of the rotatable drive element; a plurality of compressible members positioned within the battery tube assembly; a plurality of batteries positioned within the battery tube assembly; wherein the plurality of compressible members engage the least one battery; and wherein the plurality of compressible member accommodate variation in the size of the plurality of batteries and serve to hold the plurality of batteries in place within the battery tube assembly.

2. The architectural covering of claim 1 wherein the plurality of compressible members are held within a recess in an interior surface of the battery tube assembly.

3. The architectural covering of claim 1 wherein the plurality of compressible members extend a length of an interior surface of the battery tube assembly.

4. The architectural covering of claim 1 wherein the plurality of compressible members include three or four compressible members positioned within the battery tube assembly.

5. The architectural covering of claim 1 wherein the plurality of compressible members have a resilient backing with a compressible material extending outwardly therefrom.

6. The architectural covering of claim 1 wherein when in operation the battery tube assembly rotates as the rotatable drive element rotates to open and close shade material of the architectural covering.

7. The architectural covering of claim 1 further comprising a motor housing positioned within the rotatable drive element.

8. The architectural covering of claim 1 wherein the at least one compressible member is formed of wool pile.

9. The architectural covering of claim 1 wherein the architectural covering is a roller shade.

10. The architectural covering of claim 1 wherein the architectural covering is a drapery.

11. A battery tube assembly for an architectural covering comprising: a first tube extending a length between a first end and a second end and having a hollow interior; a plurality of compressible members connected to an interior surface of the first tube, the plurality of compressible member having compressible material extending into the hollow interior of the first tube; wherein the plurality of compressible members are held within a recess in the interior surface of the first tube; and wherein when a battery is positioned within the hollow interior of the first tube the battery engages the compressible material which frictionally hold the battery and accommodates for variation in size of the battery.

12. The battery tube assembly of claim 11 wherein the battery tube assembly is inserted within a rotatable drive element of an architectural covering.

13. The battery tube assembly of claim 11 wherein the compressible material extends outwardly from a resilient backing.

14. The battery tube assembly of claim 11 wherein the plurality of compressible members are formed of wool pile.

15. The battery tube assembly of claim 11 wherein three compressible members are positioned within the first tube.

16. An architectural covering, comprising: a tube extending a length and having an exterior surface and a hollow interior defined by an interior surface; a plurality of batteries positioned within the hollow interior of the tube; at least two grooves positioned in the interior surface of the tube; a compressible member positioned within the at least two grooves; and
wherein when the plurality of batteries are positioned within the hollow interior of the tube, the at least two compressible members engage and support the plurality of batteries within the tube as the tube rotates thereby operating a shade connected to the tube.

17. The architectural covering of claim 16 wherein the compressible member includes a resilient backing which is received within the at least two grooves.

18. The architectural covering of claim 17 wherein the at least two compressible members have a compressible material which extends partially into a hollow interior of the tube.
